(19) United States
(12) Patent Application Publication
(10) Pub. No.: US 2006/0285143 A1
(43) Pub. Date: Dec. 21, 2006

(54) Driver call apparatus and method using shortcut key

(75) Inventors: Yu-rim Han, Suwon-si (KR); Yong jun Cho, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/454,942

(22) Filed: Jun. 19, 2006

(30) Foreign Application Priority Data
Jun. 17, 2005 (KR) 2005-52534

(51) Int. Cl. G06F 3/12

(52) U.S. Cl. 358/1.13

(57) ABSTRACT

A driver call method for use with a system in which a host device is connected to more than one peripheral device. The method includes detecting a performance of a shortcut key operation, recognizing that the performance of the shortcut key operation is a command to call a target peripheral device that is not a default device, and calling a driver corresponding to the target peripheral device.

### CROSS-REFERENCE TO RELATED PATENT APPLICATION

This application claims the benefit of Korean Patent Application No. 2005-52534, filed on Jun. 17, 2005, in the Korean Intellectual Property Office, the disclosure of which is incorporated herein in its entirety by reference.

### BACKGROUND OF THE INVENTION

1. Field of the Invention

An aspect of the present invention relates to a driver call system, and, more particularly, to a driver call apparatus and method using a shortcut key to call a driver of a peripheral device from among a plurality of peripheral devices connected to a host but not a default peripheral device.

2. Description of the Related Art

FIGS. 1A through 1C are reference diagrams to explain a process of calling a driver of a target peripheral device by a conventional driver call method. A task of calling a driver of a peripheral device connected to a host device among a plurality of tasks performed by the host device generally requires a plurality of key operations. In more detail, FIGS. 1A through 1C are reference diagrams to explain a key operating process performed when a user, having created a document using an application program (e.g., a document using Microsoft Word), wants to print print data generated from the document. Here, four kinds of printers 118, 122, 124, and 126 are connected to the host device, and the reference number 118 indicates a default printer.

As shown in FIGS. 1A through 1C, when the user clicks a print menu 112 arrived at via an interface 110 of the application program in order to print the print data, a print order window 114 is displayed. A printer displayed on a printer dialog box 116 will normally be the default printer 118. Thus, if the user wants to print the print data using another printer 124 but not the default printer 118, the user needs to select the printer 124 from among displayed printers 122 through 126 by clicking a printer select icon 120.

The user may change the original set information related to a printing work performed by the selected printer 124 by clicking a set change icon 128. However, when a plurality of peripheral devices are connected to the host device, since a plurality of key operations should be performed in the host device to call a driver of a certain peripheral device that is not a default peripheral device in the conventional driver call method, the user may be annoyed by the need to perform the many key operations.

### SUMMARY OF THE INVENTION

An aspect of the present invention provides a driver call method using a shortcut key to call a driver of a peripheral device from among a plurality of peripheral devices connected to a host but not a default peripheral device.

An aspect of the present invention also provides a driver call apparatus using a shortcut key to call a driver of a peripheral device from among a plurality of peripheral devices connected to a host but not a default peripheral device.

An aspect of the present invention also provides a computer readable medium having recorded thereon a computer readable program to call a driver of a peripheral device from among a plurality of peripheral devices connected to a host but not a default peripheral device by the operation of a shortcut key.

According to an aspect of the present invention, there is provided a driver call method for use with a system in which a host device is connected to more than one peripheral device. The method includes detecting a performance of a shortcut key operation, recognizing that the performance of the shortcut key operation is a command to call a target peripheral device that is not a default device, and calling a driver corresponding to the target peripheral device.

The calling may comprise reading shortcut key information corresponding to the detection result. The method may further comprise: generating the shortcut key information and storing the generated shortcut key information. The shortcut key information may be identification information of a driver of the peripheral device. The host device and the peripheral device may be connected either via a network or directly to one another. The shortcut key operation may be achieved by using at least one of a keyboard, a mouse, and/or a touch screen of the host device. The shortcut key operation may be achieved by using am updatable pre-set process.

According to another aspect of the present invention, there is provided a driver call apparatus in which a host device is connected to more than one peripheral device, the apparatus comprising a shortcut key operation detector to detect a performance of a shortcut key operation, and a driver call unit to recognize that the performance of the shortcut key operation is a command to call a target of a peripheral device that is not a default device and to call a driver corresponding to target peripheral device is response.

The apparatus may further comprise: a shortcut key information search unit to search for shortcut key information corresponding to the detection result among prepared shortcut key information, wherein the driver call unit calls a driver corresponding to the searched shortcut key information from among the prepared drivers, and the shortcut key information contains identification information of the peripheral device.

The apparatus may further comprise: a shortcut key information storage unit to store shortcut key information, which contains identification information of the peripheral device, by using the detection result as an address; and a shortcut key information search unit to read shortcut key information having the detection result as an address among the stored shortcut key information.

The apparatus may further comprise: a shortcut key information generator to pre-generate the shortcut key information for every detection result.

The apparatus may further comprise: a user interface unit to provide a user interface to allow for a setting of content of the shortcut key information to a user, wherein the shortcut key information generator generates the shortcut key information having the set content.

According to another aspect of the present invention, there is provided a computer readable medium having recorded thereon at least one computer readable program to perform a method to operate a host device, which is connected to more than one peripheral device, the method comprising detecting a performance of a shortcut key operation, recognizing that the performance of the shortcut key operation is a command to call a target peripheral device that is not a default device; and calling a driver corresponding to the target peripheral device.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIGS. 1A through 1C are reference diagrams to explain a process of calling a driver of a target peripheral device by a conventional driver call method;

FIG. 2 is a block diagram of a driver call apparatus using a shortcut key according to an embodiment of the present invention;

FIG. 3 illustrates an interface of a user interface unit illustrated in FIG. 2;

FIG. 4 is a flowchart illustrating a driver call method using a shortcut key according to an embodiment of the present invention;

FIG. 5 is a flowchart illustrating a driver call method using a shortcut key, when a peripheral device is a printing device according to an embodiment of the present invention; and

FIG. 6 is a flowchart illustrating a driver call method using a shortcut key when a peripheral device is a scanning device according to an embodiment of the present invention.

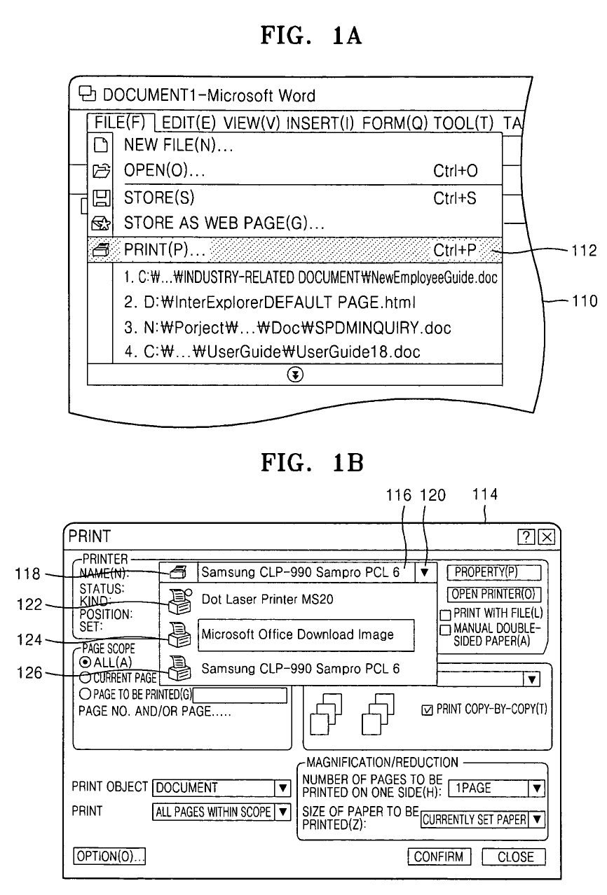

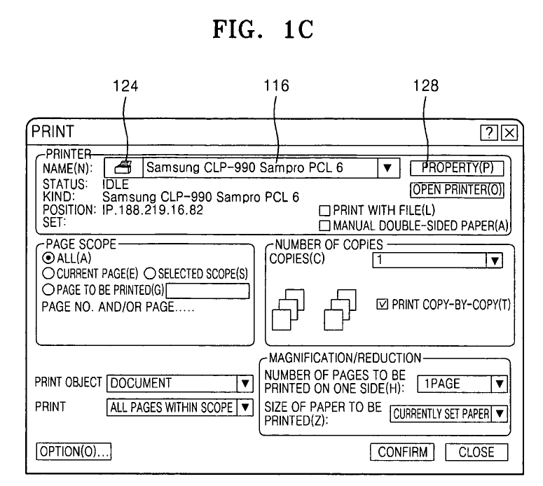

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

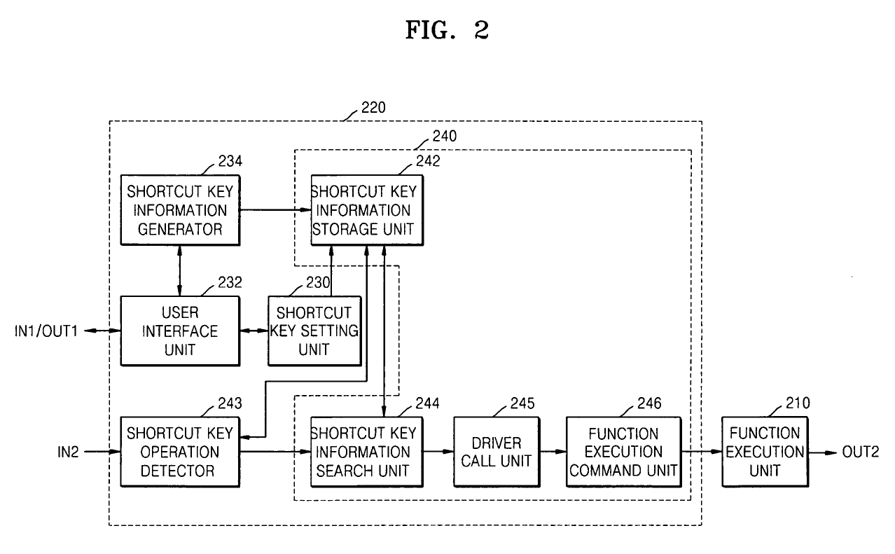

FIG. 2 is a block diagram of a driver call apparatus using a shortcut key according to an embodiment of the present invention. The apparatus includes a function execution unit 210 and a host device 220. The host device 220 includes a shortcut key setting unit 230, a user interface unit 232, a shortcut key information generator 234, a shortcut key operation detector 243, and a peripheral device driver 240. The peripheral device driver 240 includes a shortcut key information storage unit 242, a shortcut key information search unit 244, a driver call unit 245, and a function execution command unit 246.

The function execution unit 210 is included in a peripheral device (not shown) and performs a function of the peripheral device. The peripheral device may be a printer, a scanner, or a multi-function peripheral (MFP) that is driven according to an order of the host device (hereinafter referred to as “host”) 220 and is connected via a network to the host 220. That is, the peripheral device may be an output peripheral device, such as a printer, or an input peripheral device, such as a scanner. Here, the input/output device is defined according to the host 220. If the peripheral device is a printing device such as a printer, the function execution unit 210 may perform printing, and if the peripheral device is a scanning device such as a scanner, the function execution unit 210 may perform scanning.

The term, “OUT2” refers to a result obtained by the function execution unit 210 performing the above-described appropriate function. For example, if the function execution unit 210 employs a printing function, OUT2 refers to the printing of a printed document, and, if the function execution unit 210 employs a scanning function, OUT2 refers to scan data generated by the scanning of a document.

The host 220 prepares a key, a user uses the key, and the host 220 drives the peripheral device according to the result of using the key. Here, if the host 220 is a personal computer (PC), the key may be made with at least one of a keyboard and a mouse. The host 220 performs various operations or functions according to key operations of the user. For example, if the host 220 is a PC, the user may perform a graphic work and word processing using the host 220. To do this, various application programs (e.g., a word processing program such as Microsoft word), may be performed in the host 220.

The user may also command an operation of the function execution unit 210 while work is being performed by an application program of the host 220. For example, the user may command the function execution unit 210 included in a printing device (not shown) via the host 220 to print data. Here, the data being printed is data generated by a word processing program. The user may also command an operation of the function execution unit 210 regardless of a work by an application program. For example, the user may command scanning of a document prepared for a scanning device (not shown) via the host 220, which is not performing scanning. According to such a command, the function execution unit 210 starts operating, and the peripheral device is then driven.

For such a command, a plurality of key operations is generally required. In more detail, if a plurality of peripheral devices are connected to the host 220, and, if the user intends to command an operation of the function execution unit 210 of a target peripheral device from among the plurality of peripheral devices, the user generally needs to perform a plurality of key operations. Here, the target peripheral device is a target peripheral device that the user intends to operate from among the plurality of peripheral devices.

In particular, if the target peripheral device is different from a default peripheral device, a plurality of key operations must be performed. To operate the target peripheral device via the host 220, a driver of the target peripheral device should be called to the host 220 according to a command of the user.

Driver information of the default peripheral device is displayed on a user interface window displayed by the host for the first time, and the user needs to perform a plurality of key operations so that driver information of the target peripheral device is displayed on the user interface window.

Driver information includes identification information and operational attribute information of a peripheral device corresponding to the driver. Here, identification information of a driver refers to position information of a peripheral device corresponding to the driver from among a plurality of peripheral devices. Operational attribute information of a driver is information on how the function execution unit 210 of a peripheral device corresponding to the driver performs.

Even if the target peripheral device is the default peripheral device, if operational attribute information of a driver of the default peripheral device, which is information on how the function execution unit 210 performs, is different from operational attribute information that the user wants, the user needs to change the operational attribute information displayed on the user interface window by performing a plurality of key operations using the host 220.

If each of a plurality of peripheral devices is connected to the host 220, default set information will almost certainly have already been prepared before the host 220 commands an operation of the function execution unit 210. The default set information is information set by default and includes identification information and operational attribute information that maintain their own values unless the user changes them. (Hereinafter, a peripheral device having the identification information included in the default set information is referred to as “a default peripheral device.”)

The identification information of the default peripheral device from among the plurality of peripheral devices is information that identifies the default peripheral device from other peripheral devices, and is, for example, position information of the default peripheral device on a network to which a plurality of peripheral devices are connected. If only one peripheral device is connected to the host 220, the identification information may not be included in the default set information.

The operational attribute information of the default peripheral device from among the plurality of peripheral devices is arbitrary set information on how the default peripheral device operates. For example, if the default peripheral device is a printing device, the operational attribute information includes information on how much print data has been printed out on a sheet of printing paper and information on how many sheets of printing paper are repeatedly printed out for the same print data.

As noted above, in conventional systems, if the host 220 intends to call a driver of a peripheral device having identification information that is different from the identification information represented by the default set information, or if the host 220 intends to command an operation of the function execution unit 210 using operational attribute information that is different from the operational attribute information represented by the default set information, the user would have been required to perform a plurality of key operations (hereinafter referred to as “a conventional key operation”) to change contents of the default set information. Thus, an aspect of the present invention relates to an apparatus to prevent this problem from arising. To this end, the user pre-sets a shortcut key, and contents of the set shortcut key are prepared in the host 220 in advance. Here, in an embodiment of the invention, the contents of the set shortcut key are stored in the host 220.

The shortcut key setting unit 230 of the host 220 sets a shortcut key according to a command of the user.

If the user operates keys a, b, and c on a keyboard of the host 220 by sequentially pressing keys a, c, and b, the operation result is (a, c, b). If keys prepared in the host 220 are constructed by using the keyboard and a mouse, the user may pre-set a shortcut key by clicking the left button of the mouse when pressing the Alt key.

When a key operation is performed according to the contents of the pre-set shortcut key, in an embodiment of the invention, the host 220 recognizes the key operation as a conventional key operation.

As an example, then, it is assumed that a plurality of peripheral devices is connected to the host 220 and that all the peripheral devices are printing devices such as printers. For the convenience of description, it is further assumed that printing devices A, B, and C are connected to the host 220, with printing device B being a default peripheral device, and that set information, which is set to repeatedly print the same print data on 2 sheets of printing paper, is prepared as operational attribute information for the printing device C in a printer driver stored in the host 220.

Here, in the conventional system, if the user intends to repeatedly print the same print data on 3 sheets of printing paper using the printing device C, the user performs more than one key operation to change position information of the printing device B, which is identification information included in default set information, to position information of the printing device C and also performs more than one key operation to change the content of the operational attribute information. That is, the conventional key operation requires a plurality of key operations. That is, the conventional key operation requires inconvenient key operations.

To remove this inconvenience, according to the present invention, the user pre-sets a shortcut key operation to replace the conventional key operation. Here, in an embodiment of the invention, the host 220 recognizes the shortcut key operation as the conventional key operation.

For example, the Alt key and the right button of the mouse are to be set as a shortcut key to change the default peripheral device from the printing device B to the printing device C and to change the operational attribute information of the printing device C as described above. In this case, if the user clicks the right button of the mouse when pressing the Alt key, the host 220 recognizes the key operation as the conventional key operation described above.

In an embodiment of the invention, such a shortcut key operation is set so that the key operation is to be performed with a lesser number of key operations than the number of key operations required in the conventional systems.

The setting of such an operational pattern may be performed to correspond to substantially every conventional key operation which the user frequently performs.

The user interface unit 232 allows the user to use a user interface to set the contents of a shortcut key. The term “OUT1” denotes the user interface provided to the user, and IN1 denotes the contents of the shortcut key commanded by the user. The shortcut key setting unit 230 sets a shortcut key according to the commanded contents.

For the host 220 to recognize a shortcut key operation as a conventional key operation, in an embodiment of the invention, the shortcut key information that corresponds to the contents of the shortcut key should be pre-stored in the host 220. Here, the shortcut key information is default set information changed by the conventional key operation. In a further embodiment of the invention, such shortcut key information should be prepared for every set shortcut key. To this end, the shortcut key information generator 234 may be included in the host 220.

The shortcut key information generator 234 generates shortcut key information for every set shortcut key. Here, the shortcut key information generator 234 may generate shortcut key information according to a command of the user that is input through the user interface provided by the user interface unit 232. In this case, the term “IN1” denotes the contents of the shortcut key information commanded by the user, and “OUT1,” as noted above, denotes the user interface to set the contents of the shortcut key information as the user interface provided by the user interface unit 232.

The shortcut key information storage unit 242 may store the contents of the shortcut key that are set by the shortcut key setting unit 230. In addition, the shortcut key information storage unit 242 stores the shortcut key information that is generated by the shortcut key information generator 234. Here, the shortcut key information storage unit 242 stores the shortcut key information by a method one-to-one matching of the contents of the shortcut key to the shortcut key information. For example, the shortcut key information storage unit 242 stores the shortcut key information using the contents of the shortcut key as an address.

The shortcut key operation detector 243 senses that a shortcut key operation is performed, and, if the shortcut key operation is sensed, the shortcut key operation detector 243 recognizes the key operation result. Here, the term “IN2” denotes a performed key operation. The shortcut key operation detector 243 may be referred to as “a status monitor.”

The shortcut key operation detector 243 transmits the recognized result to the shortcut key information search unit 244 and then commands the shortcut key information search unit 244 to operate. The shortcut key information search unit 244 then searches the shortcut key information storage unit 242 for shortcut key information corresponding to the recognized result. In more detail, the shortcut key information search unit 244 reads shortcut key information having the recognized result as an address from the shortcut key information storage unit 242.

The driver call unit 245 calls a driver corresponding to the read shortcut key information. In more detail, if identification information of a peripheral device is included in the shortcut key information, the driver call unit 245 calls a driver of the peripheral device. Likewise, besides the identification information of the peripheral device, if operational attribute information is further included in the shortcut key information, the driver call unit 245 calls a driver corresponding to the operational attribute information included in the read shortcut key information.

Then, a user interface window representing information of the called driver is displayed on the host 220. That is, according to the shortcut key operation, a driver of a target peripheral device, which is not the default peripheral device, as assigned by default set information, is called, and a user interface window representing information of the driver of the target peripheral device is displayed. Here, in an embodiment of the invention, the operational attribute information displayed on the user interface window is included in the read shortcut key information.

The function execution command unit 246 drives the function execution unit 210 according to the read shortcut key information. In more detail, the function execution command unit 246 receives a function execution command through the user interface window of the driver called by the driver call unit 245 and commands the function execution unit 210 to operate.

The function execution unit 210 operates according to the read shortcut key information. For example, if a plurality of peripheral devices are connected to the host 220, the function execution command unit 246 drives the function execution unit 210 so that a peripheral device having identification information included in read shortcut key information is driven according to operational attribute information included in the read shortcut key information.

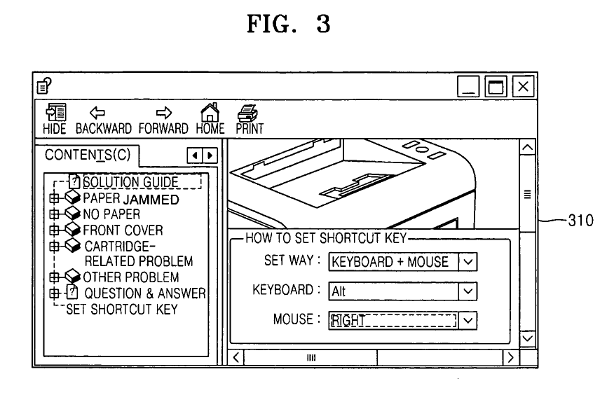

FIG. 3 illustrates an interface 310 of the user interface unit 232 illustrated in FIG. 2, according to an embodiment of the present invention. In more detail, FIG. 3 shows an example of the user interface 310 provided by the user interface unit 232 in order for the shortcut key setting unit 230 to set a shortcut key. Here, the user interface 310 allows for an input of the contents of the shortcut key by the user. Referring to FIG. 3, the shortcut key setting unit 230 may set a shortcut key composed of the Alt key and the right button of the mouse as an example of the shortcut key.

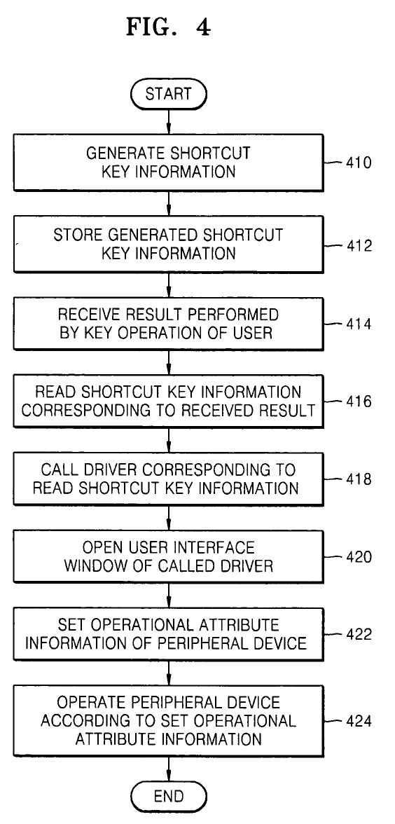

FIG. 4 is a flowchart illustrating a driver call method using a shortcut key according to an embodiment of the present invention. The method includes generating and storing shortcut key information in operations 410 and 412 and receiving a result obtained by operating the shortcut key and calling a driver corresponding to shortcut key information corresponding to the result of operations 414 through 424.

Referring to FIG. 4, in operation 410, the shortcut key setting unit 230 sets a shortcut key according to a user command that is input through a user interface provided by the user interface unit 232. The shortcut key information generator 234 generates shortcut key information corresponding to the contents of the shortcut key. In operation 412, the generated operational pattern and shortcut key information are stored in the shortcut key information storage unit 242. In operation 414, the shortcut key operation detector 243 recognizes a key-operated result according to a shortcut key operation of a user. In more detail, the shortcut key operation detector 243 monitors a performed key operation and determines whether stored contents of a shortcut key corresponding to key values input by the key operation exist. If the corresponding contents of a shortcut key exist, in operation 416, the shortcut key information search unit 244 reads shortcut key information corresponding to the contents of the shortcut key. In operation 418, the driver call unit 245 calls a driver corresponding to the read shortcut key information. In operation 420, the user interface unit 232 displays a user interface window of the called driver. If the user intends to change displayed operational attribute information, in operation 422, the user interface unit 232 inputs the changed operational attribute information from the user. In operation 424, the function execution command unit 246 commands an operation of the target peripheral device according to the input operational attribute information, and the function execution unit 210 operates the target peripheral device.

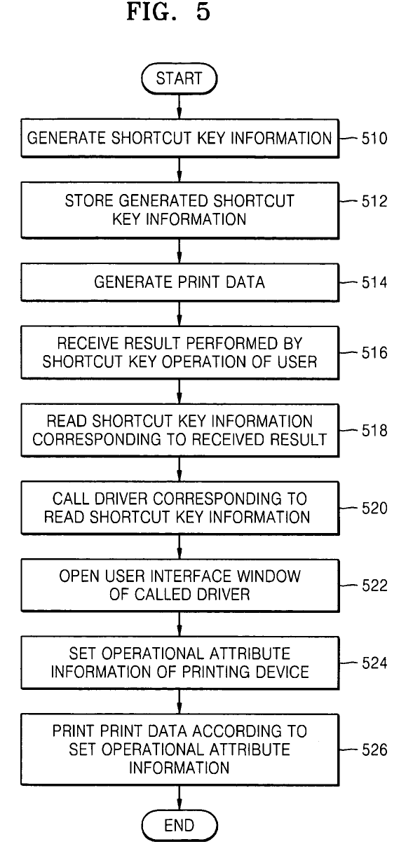

FIG. 5 is a flowchart illustrating a driver call method using a shortcut key, when a peripheral device is a printing device according to an embodiment of the present invention. The method includes generating and storing shortcut key information in operations 510 and 512 and receiving a result that is obtained by operating the shortcut key and then printing print data according to shortcut key information corresponding to the result of operations 514 through 526.

Referring to FIG. 5, in operation 510, the shortcut key setting unit 230 sets a shortcut key according to a user command input through a user interface provided by the user interface unit 232, and the shortcut key information generator 234 generates shortcut key information corresponding to the contents of the shortcut key. In operation 512, the generated operational pattern and shortcut key information are stored in the shortcut key information storage unit 242. In operation 514, print data is generated in the host 220 by an application program, such as a word processing program. The user performs a predetermined key operation to print the print data. Here, according to conventional methods, if the user intended to print the print data in a different manner from the contents of default set information, the user would have had to perform a plurality of key operations. However, an aspect of the present invention suggests a use of a technology to replace a conventional key operation with a shortcut key operation, where the user is able to perform the shortcut key operation instead of the conventional key operation. Accordingly, in operation 516, the shortcut key operation detector 243 receives a result that is obtained by a performance of the shortcut key operation. In more detail, the shortcut key operation detector 243 monitors the performed key operation and determines whether stored contents of a shortcut key corresponding to key values input by the key operation exist.

If the corresponding contents of a shortcut key exist, in operation 518, the shortcut key information search unit 244 reads shortcut key information corresponding to the contents of the shortcut key. In operation 520, the driver call unit 245 calls a driver corresponding to the read shortcut key information. In operation 522, the user interface unit 232 displays a user interface window of the called driver. If the user intends to change displayed operational attribute information, in operation 524, the user interface unit 232 inputs the changed operational attribute information from the user. In operation 526, the function execution command unit 246 commands an operation of the target printing device according to the input operational attribute information, and the function execution unit 210 that is prepared in the target printing device prints the print data.

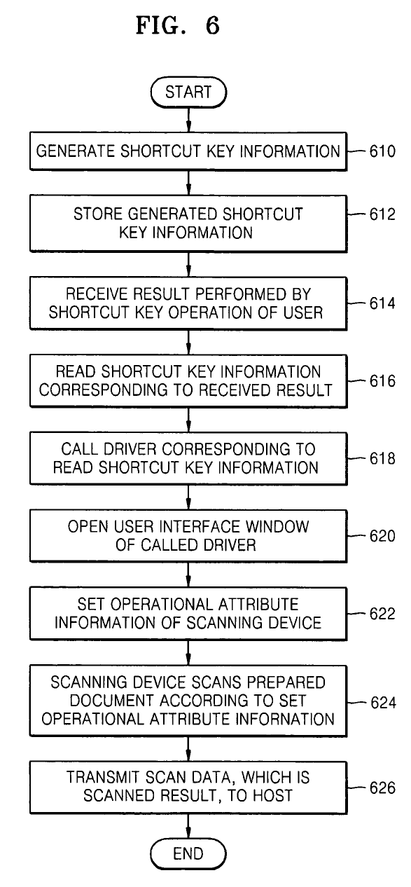

FIG. 6 is a flowchart illustrating a driver call method using a shortcut key when a peripheral device is a scanning device according to an embodiment of the present invention. The method includes generating and storing shortcut key information in operations 610 and 612 and receiving a result obtained by operating the shortcut key and scanning according to shortcut key information corresponding to the result in operations 614 through 626.

As shown in FIG. 6, in operation 610, the shortcut key setting unit 230 sets a shortcut key according to a user command input through a user interface provided by the user interface unit 232, and the shortcut key information generator 234 generates shortcut key information corresponding to the contents of the shortcut key. In operation 612, the generated shortcut key information is stored in the shortcut key information storage unit 242.

The user then performs a predetermined key operation to operate the scanning device. In an embodiment of the invention, a document to be scanned is prepared in the scanning device. Here, according to the conventional methods, if the user intended to scan the document in a different manner from the contents of default set information, the user would have had to perform a plurality of key operations. That is, in that case, the user changed the default set information by performing the plurality of key operations. However, an aspect of the present invention suggests a use of a technology to replace a conventional key operation with a shortcut key operation, where the user is able to perform the shortcut key operation instead of the conventional key operation. Accordingly, in operation 614, the shortcut key operation detector 243 receives a result obtained by performing the shortcut key operation. In more detail, the shortcut key operation detector 243 monitors the performed key operation and determines whether stored contents of a shortcut key corresponding to key values input by the key operation exist.

If the corresponding contents of a shortcut key exist, in operation 616, the shortcut key information search unit 244 reads shortcut key information corresponding to the contents of the shortcut key. In operation 618, the driver call unit 245 calls a driver corresponding to the read shortcut key information. In operation 620, the user interface unit 232 displays a user interface window of the called driver. If the user intends to change displayed operational attribute information, in operation 622, the user interface unit 232 inputs the changed operational attribute information from the user. In operation 624, the function execution command unit 246 commands the target scanning device to scan the prepared document according to the input operational attribute information, and in operation 626, the function execution unit 210 prepared in the target scanning device transmits scan data, which is the scanned result, to the host 220.

The present invention may be embodied in a general-purpose computer by running a program from a computer-readable medium, including but not limited to storage media such as magnetic storage media (ROMs, RAMs, floppy disks, magnetic tapes, etc.), optically readable media (CD-ROMs, DVDs, etc.), and carrier waves (transmission over the internet), or combinations thereof. The present invention may also be embodied as a computer-readable medium having a computer-readable program code unit embodied therein to cause a number of computer systems connected via a network to effect distributed processing.

As is described above, according to embodiments of the present invention, in a driver call apparatus and method using a shortcut key, when a plurality of peripheral devices are connected to a host, a plurality of key operations required to call a driver of a peripheral device that is not a default peripheral device may be replaced with a pre-set shortcut key operation. Furthermore, a plurality of key operations required to call the particular driver may be replaced with a pre-set shortcut key operation. Accordingly, the user may call a driver of a target peripheral device according to a demand of the user without performing a plurality of annoying key operations.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A driver call method for use with a system in which a host device is connected to more than one peripheral device, the method comprising:
detecting a performance of a shortcut key operation;
recognizing that the performance of the shortcut key operation is a command to call a target peripheral device that is not a default device; and
calling a driver corresponding to the target peripheral device.

2. The method of claim 1, wherein the calling comprises reading shortcut key information corresponding to the result of the detection of the performance of the shortcut key operation from among prepared shortcut key information.

3. The method of claim 2, further comprising:
generating the shortcut key information; and
storing the generated shortcut key information.

4. The method of claim 2, wherein the shortcut key information comprises identification information of the driver corresponding to the target peripheral device.

5. The method of claim 3, wherein the shortcut key information comprises identification information of the driver corresponding to the target peripheral device.

6. The method of claim 1, wherein the host device and the peripheral device are connected either via a network or directly with one another.

7. The method of claim 1, wherein the shortcut key operation is achieved using at least one of a keyboard, a mouse, and/or a touch screen of the host device.

8. The method of claim 1, wherein the shortcut key operation is achieved according to an updatable pre-set process.

9. A driver call apparatus in which a host device is connected to more than one peripheral device, the apparatus comprising:
a shortcut key operation detector to detect a performance of a shortcut key operation; and
a driver call unit to recognize that the performance of the shortcut key operation is a command to call a target of a peripheral device that is not a default device and to call a driver corresponding to target peripheral device is response.

10. The apparatus of claim 9, further comprising a shortcut key information search unit to search for shortcut key information corresponding to the detection result from among prepared shortcut key information.

11. The apparatus of claim 9, further comprising:
a shortcut key information storage unit to store shortcut key information, which contains identification information of the corresponding peripheral device, using the detection result as an address; and
a shortcut key information search unit to read shortcut key information having the detection result as an address from among the stored shortcut key information.

12. The apparatus of claim 9, further comprising a shortcut key information generator to pre-generate the shortcut key information for every detection result.

13. The apparatus of claim 10, further comprising a shortcut key information generator to pre-generate the shortcut key information for every detection result.

14. The apparatus of claim 9, wherein the shortcut key information comprises identification information of the driver corresponding to the target peripheral device.

15. The apparatus of claim 10, wherein the shortcut key information comprises identification information of the driver corresponding to the target peripheral device.

16. The apparatus of claim 9, wherein the host device and the peripheral device are connected either via a network or directly with one another.

17. The apparatus of claim 9, wherein the shortcut key operation is achieved by using at least one of a keyboard, a mouse, and/or a touch screen of the host device.

18. The apparatus of claim 9, wherein the shortcut key operation is achieved according to an updatable pre-set process.

19. The apparatus of claim 9, wherein the shortcut key operation is detected by a status monitor of the host device.

20. The apparatus of claim 12, further comprising a user interface unit to provide a user interface to a user through which content of the shortcut key information is to be set, wherein the shortcut key information generator generates the shortcut key information having the set content.

21. A computer readable medium having recorded thereon at least one computer readable program to perform a method to operate a host device, which is connected to more than one peripheral device, the method comprising:
detecting a performance of a shortcut key operation;
recognizing that the performance of the shortcut key operation is a command to call a target peripheral device that is not a default device; and
calling a driver corresponding to the target peripheral device.

22. A driver call method for use with a system in which a host device is connected to more than one peripheral device including a target peripheral device, the method comprising:
detecting a performance of a shortcut key operation; and
calling a driver of the target peripheral device corresponding to the detected shortcut key operation.

23. A computer readable medium on which a program is stored to execute the method of claim 22.
